(19) United States
(12) Patent Application Publication
(10) Pub. No.: US 2018/0285915 A1
(43) Pub. Date: Oct. 4, 2018

(54) TRANSACTION MONITORING SYSTEM AND METHOD

(71) Applicant: MASTERCARD INTERNATIONAL INCORPORATED, Purchase, NY (US)

(72) Inventors: Piyush Sharma, Pune (IN); Elson Rodrigues, Mumbai (IN)

(21) Appl. No.: 15/917,354

(22) Filed: Mar. 9, 2018

(30) Foreign Application Priority Data
Mar. 14, 2017 (IN) 201711008732

(51) Int. Cl. G06Q 30/02

(52) U.S. Cl. CPC G06Q 30/0233; G06Q 30/0238

(57) ABSTRACT

A method for monitoring customer transactions is provided, the method including, in at least one payment processing device, receiving transaction data indicative a transaction between a customer and a merchant, the transaction being performed in respect of a respective customer account, determining an identifier associated with the transaction using mapping data indicative of associations between identifiers and customer accounts, determining a plurality of transactions associated with the identifier, analyzing the plurality of transactions to determine if the plurality of transactions meet one or more transaction criteria, selectively generating a notification if the plurality of transactions meet the one or more transaction criteria and providing the notification to at least one of the merchant and a customer.

### CROSS REFERENCE TO RELATED APPLICATIONS

This patent application claims priority to Indian Application No. 201711008732 filed on Mar. 14, 2017, the disclosure of which is incorporated by reference herein in its entirety as part of the present application.

### BACKGROUND

The present disclosure relates to a system and method for monitoring transactions, and in one particular example, to a system and method for monitoring transactions to provide offers or rewards to customers of a merchant.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavor to which this specification relates.

It is known to provide loyalty or reward schemes in which customers are rewarded in return for shopping with a particular merchant. Typically such schemes are run by individual merchants or groups of merchants, with the merchants operating their own infrastructure in order to administer the rewards scheme. Consequently, this places a burden on the merchants, whilst also requiring users to have loyalty cards or similar in addition to their usual payment mechanism.

### BRIEF DESCRIPTION

In one broad form the present disclosure seeks to provide a method for monitoring customer transactions, the method including, in at least one payment processing device:
a) receiving transaction data indicative of a transaction between a customer and a merchant, the transaction being performed in respect of a respective customer account;
b) determining an identifier associated with the transaction using mapping data indicative of associations between identifiers and customer accounts;
c) determining a plurality of transactions associated with the identifier;
d) analyzing the plurality of transactions to determine if the plurality of transactions meet one or more transaction criteria;
e) selectively generating a notification if the plurality of transactions meet the one or more transaction criteria; and
f) providing the notification to at least one of the merchant and a customer.

In one broad form the present disclosure seeks to provide a system for monitoring customer transactions, the system including at least one payment processing device that:
g) receives transaction data indicative a transaction between a customer and a merchant, the transaction being performed in respect of a respective customer account;
h) determines an identifier associated with the transaction using mapping data indicative of associations between identifiers and customer accounts;
i) determines a plurality of transactions associated with the identifier;
j) analyses the plurality of transactions to determine if the plurality of transactions meet one or more transaction criteria;
k) selectively generates a notification if the plurality of transactions meet the one or more transaction criteria; and
l) provides the notification to at least one of the merchant and a customer.

It will be appreciated that the broad forms of the disclosure and their respective features can be used in conjunction, interchangeably and/or independently, and reference to separate broad forms is not intended to be limiting.

### BRIEF DESCRIPTION OF THE DRAWINGS

An example of the present disclosure will now be described with reference to the accompanying drawings, in which:

FIG. 1 is a flow chart of an example of a method for monitoring customer transactions;

FIG. 2 is a schematic diagram of an example of a system for monitoring customer transactions;

FIG. 3 is a schematic diagram of an example of a processing system;

FIG. 4 is a specific example of a merchant terminal;

FIG. 5 is a schematic diagram of an example of a client device;

FIG. 6 is a block diagram showing an example of the functionality of the system of FIG. 2; and

FIGS. 7A to 7E are a specific example of a method for monitoring customer transactions.

### DETAILED DESCRIPTION

The present disclosure operates to monitor customer transactions to establish when customer transactions meet certain criteria. The transactions are monitored by a payment processing device that is utilized in order to process transactions, for example forming part of a backend payment system, such as a payment network server that routes payment details between financial institutions as part of an existing payment process. This allows the transactions to be monitored as part of the normal transaction process, avoiding the need to have a separate monitoring system established for example allowing merchants to monitor their own transactions as typically occurs with loyalty cards or other similar schemes.

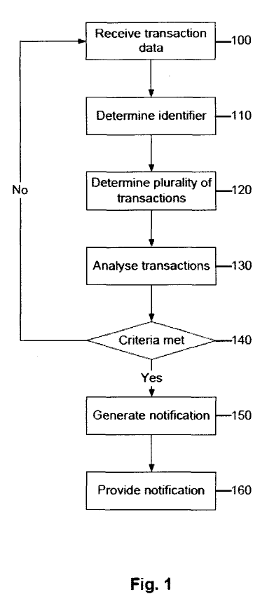

An example of a process for monitoring transactions between merchants and customers will now be described with reference to FIG. 1.

For the purpose of these examples, it is assumed that the transactions are performed and monitored at least in part utilizing one or more payment processing device(s) that are typically part of one or more processing systems, such as one or more servers, and may form part of a payment network backend, or similar. For the following description reference will generally be made to a single payment processing device, but it will be appreciated that the functionality performed by the payment processing device could in practice be distributed across multiple processing devices and associated systems, and reference to a single device is not intended to be limiting.

The payment processing device can be in communication with a one or more client devices, such as a merchant or customer client device and/or a merchant terminal associated with a merchant. The client devices can be a suitably programmed mobile communications device, such as a mobile phone, tablet, a suitably programmed computer system, or the like, whilst the merchant terminal can be any form of device capable of being used in a transaction and could include a POS (Point of Sales) terminal, payment terminal, a suitably enabled merchant client device, for example a tablet incorporating a payment application and optional card scanning capabilities, or the like. It will however be appreciated that a wide range of different devices could be used and the examples given are for the purpose of illustration only.

In this example, at step 100 the payment processing system receives transaction data indicative of a transaction between a customer and a merchant, the transaction being performed in respect of a respective customer account. This can be achieved in any one of a number of manners but typically involves receiving the transaction data from the merchant terminal either during or after the transaction is performed. The transaction data can form part of the normal data communication between the merchant terminal and a payment network, and could include payment authorization requests or batch transaction data, and could be received directly or routed via an acquirer depending upon the preferred implementation.

At step 110 an identifier associated with the transaction is determined using mapping data indicative of associations between customer accounts and identifiers. In this regard, each customer account is typically associated with at least one unique identifier, which may also be associated with one or more respective merchants. Each identifier can also be associated with one or multiple customer accounts depending upon the preferred implementation as will be described in more detail below. Identifiers are typically allocated to customer accounts for example when a customer registers to participate in a loyalty or reward scheme, with this information being stored as part of the mapping data. Accordingly, the payment processing system can operate to access the mapping data and use this to identify a particular identifier associated with the customer account that was used to perform the transaction.

At step 120 the payment processing system operates to determine a plurality of transactions associated with the identifier. In this regard, each time a transaction is performed, a record of this is stored together with an indication of the respective identifier, allowing the payment processing system to retrieve records of previous transactions that have been performed and that are associated with the respective identifier.

At step 130 the transactions are analyzed to determine if the plurality of transactions meet one or more transaction criteria. The transaction criteria can be of any appropriate form but typically relate to transaction volumes in some manner, including but not limited to a transaction frequency, a total number of transactions, a total magnitude of transactions, a number of products purchased, or the like. Thus, for example, this can involve examining if a certain amount has been spent with the merchant, if a certain number of transactions have been performed in a given time period, or the like.

At step 140 it is determined if the criteria are met and if not the process returns to step 100 to await further transaction data. However, if it is determined one or more of the criteria are met, at step 150 the payment processing system generates a notification which can then be provided to either a merchant and/or customer at step 160. The notification can be of any appropriate form and may be provided to the merchant or customer through any appropriate mechanism, such as sending a system message to a merchant terminal, or transferring a message to an application executed by a client device of the customer or the merchant. The nature of the notification will vary depending upon the preferred implementation but in one example, the notification is used to notify the merchant that criteria have been met or to notify a customer of an available offer.

Accordingly, the above described monitoring process operates to monitor customer transactions to establish when customer transactions meet certain criteria. The transactions are monitored by a payment processing device that is utilized in order to process transactions, for example forming part of a backend payment system, such as a payment network server that routes payment details between financial institutions as part of an existing payment process. This allows the transactions to be monitored as part of the normal transaction process, avoiding the need to have a separate monitoring system established for example allowing merchants to monitor their own transactions as typically occurs with loyalty cards or other similar schemes.

Additionally, as all transactions are routed via the payment processing system, this allows multiple customer accounts, even accounts held with different card issuers, to be monitored automatically, enabling the system to operate without requiring custom cards associated with the scheme. This also allows multiple different accounts to be associated with a common identifier, enabling purchases by multiple customers to be consolidated in order to collectively access rewards or offers, for example to allow family members to participate in a collective rewards scheme.

A number of further features will now be described.

In one example, the method includes having the payment processing system update stored transaction record data in accordance with the transaction data. In this example, when details of a transaction are received as part of the transaction data, these details are added to stored transaction record data, together with an indication of the respective identifier associated with the transaction, so that this can be used to subsequently determine the plurality of transactions that have been performed relating to the identifier. This enables all transactions to be automatically monitored irrespective of where or how the transaction is performed.

Each identifier can be associated with a plurality of customer accounts which can in turn relate to one or more customers. This allows multiple customers to be associated with a single identifier so that these customers can be rewarded collectively. For example, this allows family members to pool their transactions in working towards a particular reward or offer. Additionally, this allows a single user to associate multiple different accounts with a common identifier so that they can benefit even if different accounts are used for transactions with a merchant.

In one example, each identifier can be related to a primary customer account and one or more secondary customer accounts. In this instance notification of any reward or offer is provided to a customer associated with the primary customer account, allowing a single individual to be in charge of redeeming offers. However, this is not essential, and additionally and/or alternatively, notifications can be provided to each customer having an account associated with the identifier, or alternatively to the customer that most recently performed a transaction.

Each identifier is typically associated with at least one respective merchant. In this case, the method typically includes determining a merchant identity indicative of an identity of a merchant associated with a transaction from the transaction data and then determining the identifier for the transaction using the mapping data and the merchant identity. Thus, it will be appreciated that a single customer would typically have accounts associated with multiple different identifiers for multiple different merchants. This allows offers to be provided on a per merchant basis. However this is not essential and it will be appreciated that multiple different merchants could be associated with a single identifier, for example allowing multiple related merchants to use a common identifier.

In one example, each merchant is able to define their own respective criteria, allowing the merchant to tailor the particular set of circumstances that result in a reward or loyalty bonus so that this fits with their business goals. In this example, the one or more criteria for the respective merchant are typically stored as part of criteria data, with these being stored on the basis of an identifier so that these can be subsequently retrieved and used to determine if the criteria have been met.

In one example, the method includes providing the notification to a merchant terminal of the merchant, a merchant client device of the merchant or a customer client device of the customer. This can be used to notify either the merchant or customer that criteria have been met or the customer that an offer has been granted. In one example, the notification is a criteria notification provided to the merchant, either via the merchant terminal on which the transaction is performed, and/or a separate merchant client device, with the criteria notification being indicative of the one or more criteria met with the plurality of transactions, and/or the identifier. Alternatively, the notification can be an offer notification provided to the customer with the offer notification being indicative of at least one offer associated with the merchant.

In an example, the payment processing system determines an offer based on the criteria met and provides an offer notification to at least one customer client device with the offer notification being indicative of the at least one offer and the customer client device being responsive to display an indication of the offer to the customer. Thus, the payment processing system determines the offer that is to be made to the customer, and provide a notification of this to the customer.

The offer can be determined in any one of a number of ways and could be predefined and stored by the payment processing system, allowing the offer to be automatically retrieved by the payment processing device on the basis of the criteria met, such as if a set number or value of transactions has been reached. Thus, this allows the offer to be determined automatically by the payment processing device, avoiding the need for intervention by the merchant.

Alternatively, the payment processing system may be adapted to provide a criteria notification to a merchant terminal or merchant client device, with the criteria notification being indicative of the one or more criteria which have been met, and with the merchant terminal or client device being responsive to determine an offer and provide an indication of the offer to the payment system. In this case, the offer could be determined by the merchant terminal or merchant client device automatically, based on locally stored offer data, or could be achieved by displaying an indication of the met criteria allowing the offer to be determined in accordance with merchant input commands allowing this to be performed manually by the merchant on an ad hoc basis. In this example, this provides the merchant with greater control over the issuance of offers, and can allow merchants to define offers dynamically, increasing the flexibility of the system.

Once an offer has been displayed to a customer, an indication of offer acceptance can be provided from the customer client device with an acceptance notification being provided to the merchant terminal and/or client device, allowing the merchant to fulfil the offer as required. Alternatively, the offer can simply be performed by the payment processing device. Thus, it will be appreciated that the offer can be performed in any one of a number of ways and this could be done in store, for example by displaying the identifier to the merchant, so that the merchant can then provide the offer to a customer presenting the identifier, or alternatively could be performed by the payment system for example having the payment system credit a customer account, adjust debiting of a customer account, or the like. Thus, the offer could be formed from a refund or reduced cost of the current or a subsequent transaction. It will also be appreciated that other forms of offer could be provided, with these being redeemed in an appropriate manner as required.

The payment processing system is also adapted to cause a payment associated with the transaction to be performed. In one example, this includes acquiring transaction data from an acquirer processing system and then providing a payment file indicative of transaction details to an issuer, with the issuer being responsive to the payment file to cause an acquirer payment to be made from an issuer account to an acquirer account. The acquirer can then cause a merchant payment to be made from the acquirer account to a merchant account.

Thus, it will be appreciated that the payment processing device typically forms part of a payment network utilized in order to connect acquirers and/or issuers, in which case the payment processing device typically at least partially causes the transaction to be performed, for example by transferring transaction data and/or other messages between the issuer and acquirer in accordance with standard transaction processes.

The transaction process can include having the payment processing device receive the transaction data from at least one acquirer processing system. In this regard, the merchant terminal typically provides an indication of the transaction to at least one acquirer processing system, with the acquirer processing system providing the transaction data to the payment processing device. The payment processing device then generates a payment file indicative of the transaction details and transfers the payment file to an issuer, the issuer being responsive to the payment file to cause an acquirer payment to be made from an issuer account to an acquirer account, with the an acquirer processing device causing a merchant payment to be made from an acquirer account to a merchant account. However, it will be appreciated that the transaction monitoring process can be implemented as part of any backend payment system, and the example described is not intended to be limiting.

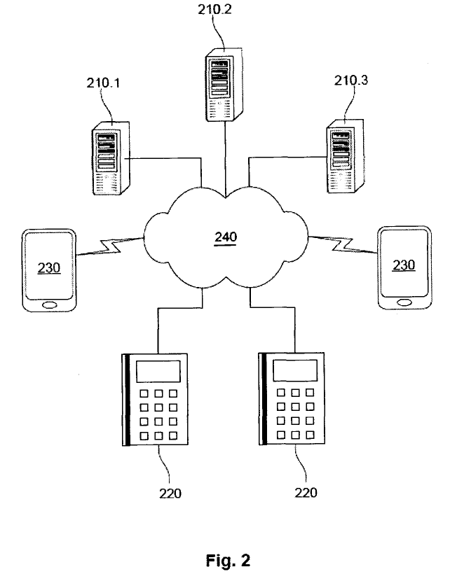

In one example, the process is performed by one or more processing systems operating as part of a distributed architecture, an example of which will now be described with reference to FIG. 2.

In this example, a number of processing systems 210 are provided coupled to one or more merchant terminals 220, and one or more client devices 230, via one or more communications networks 240, such as the Internet, and/or a number of local area networks (LANs).

The processing systems 210 are typically operated by parties, such as acquirers, service providers and issuers, and in one example, three types of processing devices, corresponding to acquirer processing systems 210.1, payment network processing systems 210.2 and issuer processing systems 210.3 are shown for the purpose of illustration only. However, it will be appreciated that any number of processing systems and similarly any number of merchant terminals 220 could be provided, and the current representation is for the purpose of illustration only. The configuration of the networks 240 is also for the purpose of example only, and in practice the processing systems 210, merchant terminals 220 and client device 230 can communicate via any appropriate mechanism, such as via wired or wireless connections, including, but not limited to mobile networks, private networks, such as an 802.11 networks, the Internet, LANs, WANs, or the like, as well as via direct or point-to-point connections, such as Bluetooth, or the like.

In use, the processing systems 210, are adapted to be perform various data processing tasks forming part of a transaction process, and the particular functionality will vary depending on the particular requirements. For example, the processing systems can be adapted to determine transaction details, determine transaction fees, perform authentication, perform payments, or cause further payment systems (not shown), such as servers of financial institutions, payment gateways or the like, to perform payments, as will be appreciated by persons skilled in the art.

Whilst the processing systems 210 are shown as single entities, it will be appreciated they could include a number of processing systems distributed over a number of geographically separate locations, for example as part of a cloud based environment. Thus, the above described arrangements are not essential and other suitable configurations could be used.

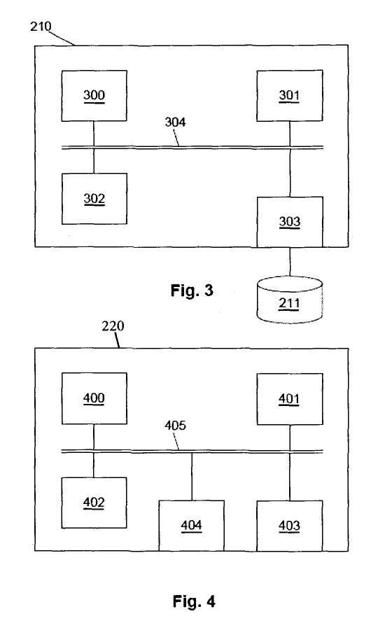

An example of a suitable processing system 210 is shown in FIG. 3. In this example, the processing system 210 includes at least one microprocessor 300, a memory 301, an optional input/output device 302, such as a keyboard and/or display, and an external interface 303, interconnected via a bus 304 as shown. In this example the external interface 303 can be utilized for connecting the processing system 210 to peripheral devices, such as the communications networks 230, databases 211, other storage devices, or the like. Although a single external interface 303 is shown, this is for the purpose of example only, and in practice multiple interfaces using various methods (eg. Ethernet, serial, USB, wireless, or the like) may be provided.

In use, the microprocessor 300 executes instructions in the form of applications software stored in the memory 301 to allow the required processes to be performed. The applications software may include one or more software modules, and may be executed in a suitable execution environment, such as an operating system environment, or the like.

Accordingly, it will be appreciated that the processing system 210 may be formed from any suitable processing system, such as a suitably programmed merchant terminal, PC, web server, network server, or the like. In one particular example, the processing system 210 is a standard processing system such as an Intel Architecture based processing system, which executes software applications stored on non-volatile (e.g., hard disk) storage, although this is not essential. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

As shown in FIG. 4, in one example, the merchant terminal 220 includes at least one microprocessor 400, a memory 401, an input/output device 402, such as a keyboard and/or display, an external interface 403, and typically a card reader 404, interconnected via a bus 405 as shown. In this example the external interface 403 can be utilized for connecting the merchant terminal 220 to peripheral devices, such as the communications networks 230 databases, other storage devices, or the like. Although a single external interface 403 is shown, this is for the purpose of example only, and in practice multiple interfaces using various methods (eg. Ethernet, serial, USB, wireless or the like) may be provided. The card reader 404 can be of any suitable form and could include a magnetic card reader, or contactless reader for reading smartcards, or the like.

In use, the microprocessor 400 executes instructions in the form of applications software stored in the memory 401, and to allow communication with one of the processing systems 210.

Accordingly, it will be appreciated that the merchant terminals 220 may be formed from any suitable merchant terminal, and could include suitably programmed PCs, Internet terminal, lap-top, or hand-held PC, POS terminals, ATMs or the like, as well as a tablet, or smart phone, with integrated or connected card reading capabilities. However, it will also be understood that the merchant terminals 220 can be any electronic processing device such as a microprocessor, microchip processor, logic gate configuration, firmware optionally associated with implementing logic such as an FPGA (Field Programmable Gate Array), or any other electronic device, system or arrangement.

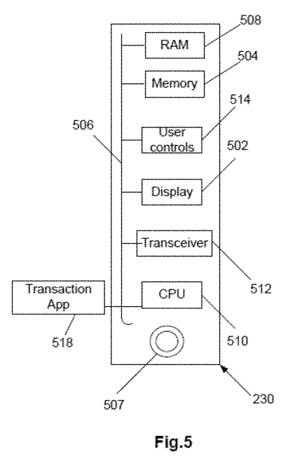

In one example, the client device 230 is a handheld computer device such as a smart phones or a PDA such as one manufactured by Apple™, LG™, HTC™, Research In Motion™, or Motorola™. In one particular example, the client device 230 includes a mobile phone or a computer such as a tablet computer. An exemplary embodiment of the client device 230 is shown in FIG. 5. As shown, the client device 230 includes the following components in electronic communication via a bus 506:
1. a display 502;
2. non-volatile memory 504;
3. random access memory (“RAM”) 508;
4. N processing components 510;
5. a transceiver component 512 that includes N transceivers;
6. user controls 514; and
7. microphone/speaker 507.

Although the components depicted in FIG. 5 represent physical components, FIG. 5 is not intended to be a hardware diagram, thus many of the components depicted in FIG. 5 may be realized by common constructs or distributed among additional physical components. Moreover, it is certainly contemplated that other existing and yet-to-be developed physical components and architectures may be utilized to implement the functional components described with reference to FIG. 5.

The display 502 generally operates to provide a presentation of content to a user, and may be realized by any of a variety of displays (e.g., CRT, LCD, HDMI, micro-projector, and OLED displays). And in general, the non-volatile memory 504 functions to store (e.g., persistently store) data and executable code including code that is associated with the functional components of a browser component and a transaction App 518. In some embodiments, for example, the non-volatile memory 504 includes bootloader code, modem software, operating system code, file system code, and code to facilitate the implementation of one or more portions of the transaction App 518 as well as other components well known to those of ordinary skill in the art that are not depicted for simplicity.

In many implementations, the non-volatile memory 504 is realized by flash memory (e.g., NAND or ONENAND memory), but it is certainly contemplated that other memory types may be utilized as well. Although it may be possible to execute the code from the non-volatile memory 504, the executable code in the non-volatile memory 504 is typically loaded into RAM 508 and executed by one or more of the N processing components 510.

The N processing components 510 in connection with RAM 508 generally operate to execute the instructions stored in non-volatile memory 504 to effectuate the functional components. As one of ordinarily skill in the art will appreciate, the N processing components 510 may include a video processor, modem processor, DSP, graphics processing unit (GPU), and other processing components.

The transceiver component 512 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

Accordingly, it will be appreciated that the client device 230 be formed from any suitably programmed processing system and could include suitably programmed PCs, Internet terminal, lap-top, or hand-held PC, a tablet, a smart phone, or the like. However, it will also be understood that the client device 230 can be any electronic processing device such as a microprocessor, microchip processor, logic gate configuration, firmware optionally associated with implementing logic such as an FPGA (Field Programmable Gate Array), or any other electronic device, system or arrangement.

Examples of the processes for monitoring transactions will now be described in further detail. For the purpose of these examples it is assumed that one or more respective processing systems 210 are servers that provide functionality required of the acquirer, the issuer and the card services provider, and will be referred to respectively as acquirer, issuer and provider servers. The servers 210 typically execute processing device software, allowing relevant actions to be performed, with actions performed by the server 210 being performed by the processor 300 in accordance with instructions stored as applications software in the memory 301 and/or input commands received from a user via the I/O device 302. It will also be assumed that actions performed by the merchant terminal 220, are performed by the processor 400 in accordance with instructions stored as applications software in the memory 401 and/or input commands received from a user via the I/O device 402, whilst actions performed by the client device 230 are performed by the processor 510 in accordance with instructions stored as applications software in the memory 504 and/or input commands received from a user via the user controls 514.

However, it will be appreciated that the above described configuration assumed for the purpose of the following examples is not essential, and numerous other configurations may be used. It will also be appreciated that the partitioning of functionality between the different processing systems may vary, depending on the particular implementation.

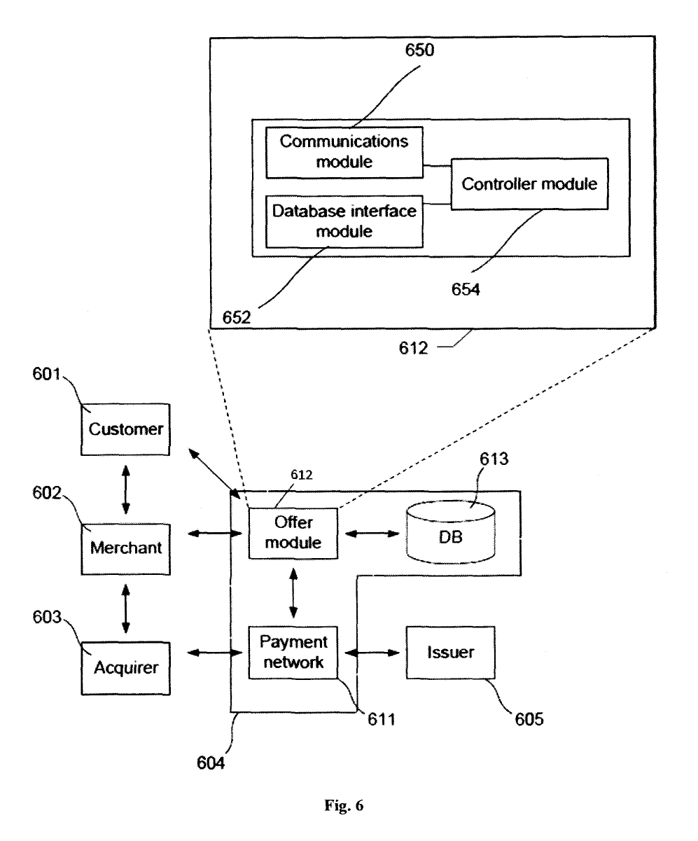

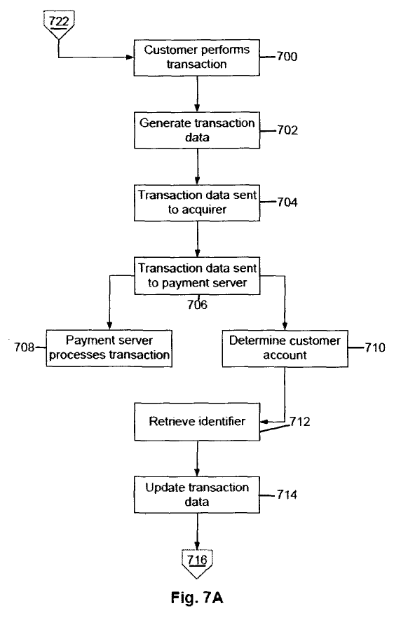

The entities involved in a transaction and their respective interactions are shown in FIG. 6.

In this example, a customer 601 interacts with a merchant 602 to perform a transaction, typically by agreeing a purchase and then providing payment details, for example by presenting a card to a merchant terminal, submitting payment details online, or the like. The merchant terminal 220 then provides transaction data to an acquirer server 210.1 of an acquirer 603, which passes this to the payment network server 210.2 of the payment network backend 604, which in turn passes this to an issuer server 210.3 of the issuer 605, allowing the issuer 605 and acquirer 603 to coordinate the payment, thereby allowing the transaction to be performed.

In this example, the payment network server 210.2 typically implements a payment network module 611 for handling routing of data between the issuer 605 and acquirer 603, as well as an offer module 612, which, with a controller module 654, monitors the transactions and controls the process of notifying merchants, determining offers, notifying customers, and the like, as will be described in more detail below. FIG. 6 also provides a detailed schematic view of the offer module 612.

The offer module 612 typically communicates directly, using a communications module 650, with the customer 601 and merchant 602, via respective client devices 230 and/or a merchant terminal, depending on the preferred implementation. Communication can be via any suitable system, and in one example is achieved by communicating with an application executed by the client devices 230, but could also be achieved by sending system messages to the merchant terminal 220, or sending email or text messages, or the like. The offer module 612 is also typically in communication, via a database interface module 652, with a database 613 that is used to store the data used by the process, including but not limited to: mapping data indicative of relationships between user accounts, merchants and identifiers, transaction data indicative of transactions performed for various identifiers, criteria data indicative of criteria defined by different merchants, and optional offer data indicative of offers defined by merchants. The data can be created during initial registration process and/or updated by the relevant entities as required.

For example, when a merchant signs up to use the system, the merchant will typically define the respective criteria that are used to trigger a notification and/or an offer process, with the criteria being adjusted as required. The merchant can also define offer data, specifying offers that are to be associated with respective met criteria if offers are to be made automatically. The merchant may also be directed to install an application on a client device allowing the merchant to interact with the offer module 612, for example to allow the merchant to update the criteria and/or offer data, and allowing the merchant to receive notifications directly from the offer module 612.

In the case of a customer, when the customer initially signs up to use the system, the customer can nominate accounts and merchants of interest, allowing unique identifiers to be associated with one or more nominated accounts for respective merchants, with this information being used to generate the mapping data. The user is also given the option of sharing the identifier, for example by supplying the contact details of other individuals, allowing the identifier to be forward to the other individuals, allowing them to create an association with one or more of their own accounts. In this instance, when such other users sign up to use the system, they can provide an indication of the respective identifier and simply nominate a respective account, allowing the mapping data to be updated accordingly. Again, customers can be provided with an application, which can be executed by the customer client device 230, allowing the user to interact with the offer module 612, to allow the user to modify details of nominated accounts or identify further merchants of interest, as well as to allow offer notifications to be received, viewed, and accepted.

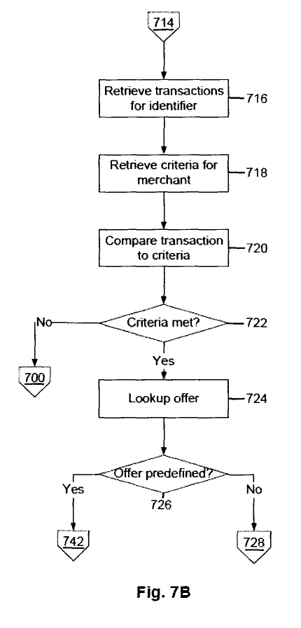

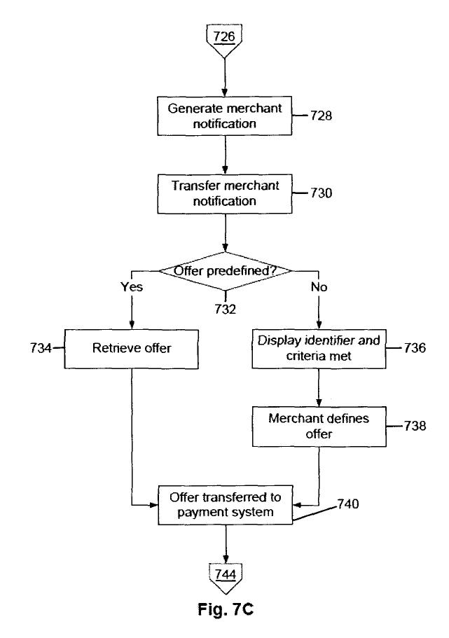

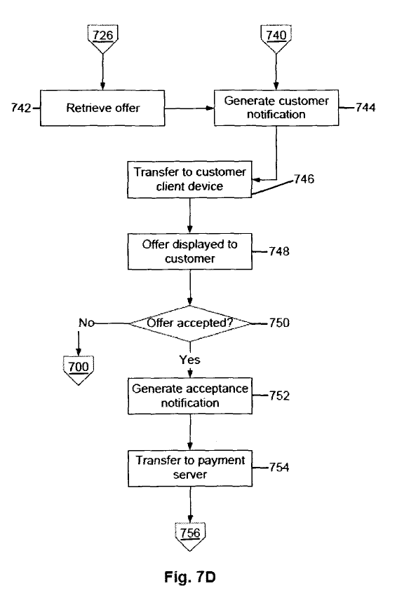

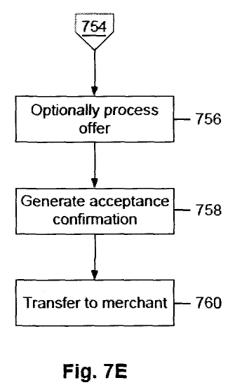

A specific example of a transaction process will now be described with reference to FIGS. 7A to 7E.

In this example, at step 700 a customer and merchant perform the transaction. This is typically achieved by having the customer present an account card, such as a credit card, debit card or the like, to the merchant terminal 220 allowing card details to be retrieved, or by supplying account detail via an online platform or the like. Account details together with a transaction amount are then used to generate transaction data at step 702, with this being sent to the acquirer at step 704. The transaction data is then sent from the acquirer to the payment network server 210.2 at step 706 allowing the payment network server 210.2 to coordinate the transaction at step 708.

The above described steps typically form part of a normal transaction process and will not therefore be described in further detail. It will however be noted that the transaction data could correspond to pre-approval data, used for approving the transaction, or could be batch data used in subsequently the transaction as part of a batch of transactions, and that both of these examples are assumed to be within the scope of the current disclosure.

At step 710, concurrently with processing the transaction, the offer module 612 of the payment network server 210.2 determines the customer account of the customer and a merchant identifier indicative of an identity of the merchant from the transaction data, and then uses this to retrieve an identifier at step 712. The identifier can be retrieved in any appropriate manner but this is typically achieved by having the offer module 612 query mapping data stored in the database 613 using the merchant identifier and an indication of the customer account to determine which identifier is associated with both the customer account and the respective merchant.

At step 714, transaction data stored in the database 613, which is indicative of transactions associated with the respective identifier are updated, with information regarding all the transactions being retrieved by the offer module 612 using the identifier at step 716. Criteria associated with the respective merchant are retrieved from the database 613 by the offer module 612 at step 718, with the transaction being compared to the merchant criteria at step 720. At step 722, the offer module 612 determines if one or more transaction criteria have been met. If not, no further action is required and the process can return to step 700 awaiting the next transaction to be performed.

Otherwise at step 724 the payment network server 210.2, and in particular the offer module 612, performs a look up to determine if an offer has been predefined in offer data stored in the database 613. If it is determined that an offer has been predefined at step 726 the process moves on to step 742, allowing the offer module 612 to retrieve details of the offer.

However, if no offer has been predefined the offer module generates a merchant notification at step 728 with the merchant notification being transferred to the merchant terminal 220 and/or merchant client device 230 at step 730. At step 732, the merchant terminal 220 and/or client device 230 determines if an offer has been predefined and is stored locally, in which case the offer is retrieved at step 734, before the process moves onto step 740. Otherwise, if an offer has not been predefined, the merchant terminal 220 and/or client device 230 operates to display the identifier and an indication of the criteria that have been met, at step 736, allowing the merchant to define an offer at step 738. In this regard, it will be noted that no information other than the criteria and indicator are provided, meaning that the merchant is now aware of any private information regarding the customer and/or customer accounts, meaning this cannot be used to influence the merchants decision regarding the offers made.

Once an offer has been determined by the merchant terminal 220 and/or merchant client device 230, this is transferred to the offer module 612 at step 740. Irrespective of whether the offer has been retrieved automatically from offer data at step 742, or received from the merchant terminal 220 or merchant client device 230, at step 744 the offer module 612 generates a customer notification indicative of the offer. The customer notification typically includes details of the offer and may define a time limit for redemption of the offer.

The customer notification is transferred to the customer's client device 230 at step 746. In this regard, the customer notification is typically sent to the client device of the customer that initially established the identifier for the merchant, but this is not essential and the customer notification could be sent to the client device of the customer performing the most recent transaction, or to any one or more of the customers having accounts associated with the identifier, depending on the preferred implementation. The notification could be of any appropriate form and could include a message, such as an SMS message, email or the like, or alternatively is a message received by the installed application on the client device, causing the application to alert the customer, and display the offer details.

Once the notification is received by the client device 230, this allows the offer to be displayed to the customer at step 748. The customer then typically has a period of time to accept the offer. If the offer is not accepted at step 750, no further action is required and the process can simply return to step 700 allowing further transactions to be monitored.

Otherwise, the customer client device 230 can generate an acceptance notification at step 752, with this being transferred to the offer module 612 at step 754. The offer can then may be processed, for example by having the payment network module 611 communicate with the acquirer and issuer servers 210.1, 210.3 processing a refund for the customer at step 756. The offer module 612 can generate an acceptance confirmation at step 758, with this being transferred to the merchant at step 760, confirming the offer was accepted, and allowing the merchant to perform any required steps. As part of this, the identifier may be provided to the merchant, allowing the customer to redeem the offer next time a transaction is performed with the merchant. For example, the customer could show the offer notification including an indication of the identifier, with the merchant matching this to the identifier provided as part of the acceptance confirmation, allowing the offer to be redeemed.

Accordingly, the above described system allows transactions performed between the merchant and the customer to be tracked using the backend payment system, which processes the transactions and in particular acts as an intermediary between the acquirer that supplies the merchant with the payment infrastructure and the issuer that issues the customers payment card. The system associates transactions with unique identifiers that can be associated with multiple accounts and/or multiple users. Transactions performed using accounts associated with an identifier are tracked and compared to criteria defined by the merchants, allowing the merchants to easily control when offers are provided. The offers can then be provided automatically, or with manual or semi-manual oversight by the merchant, depending on the preferred implementation.

It will therefore be appreciated that the above described system provides a mechanism to allow merchants to implement a loyalty or reward scheme, without the merchant having to establish any particular infrastructure. Furthermore, this allows customers to participate without requiring any specific loyalty cards.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the disclosure broadly appearing before described.

1. A method for monitoring customer transactions using at least one payment processing device: device, the method comprising:
a) receiving transaction data indicative of a transaction between a customer and a merchant, the transaction being performed in respect of a respective customer account;
b) determining an identifier associated with the transaction using mapping data indicative of associations between identifiers and customer accounts;
c) determining a plurality of transactions associated with the identifier;
d) analyzing the plurality of transactions to determine if the plurality of transactions meet one or more transaction criteria;
e) selectively generating a notification if the plurality of transactions meet the one or more transaction criteria; and
f) providing the notification to at least one of the merchant and the customer.

2. A method according to claim 1, wherein the method further comprises updating stored transaction record data in accordance with the transaction data.

3. A method according to claim 1, wherein the method further comprises determining the plurality of transactions from stored transaction record data, the transaction record data indicating transactions performed for a respective identifier.

4. A method according to claim 1, wherein each identifier is associated with a plurality of customer accounts, the plurality of customer accounts belonging to one or more customers.

5. A method according to claim 4, wherein each identifier is related to a primary customer account and one or more secondary customer accounts, and wherein the method further comprises providing the notification to at least a customer associated with the primary customer account.

6. A method according to claim 1, wherein each identifier is associated with at least one respective merchant, and wherein the method further comprises:
a) determining a merchant identity indicative of an identity of a merchant associated with the transaction from the transaction data; and
b) determining the identifier for the transaction using the mapping data and the merchant identity.

7. A method according to claim 1, wherein each identifier is related to at least one respective merchant, and wherein the method further comprises retrieving the one or more transaction criteria for the at least one respective merchant from stored criteria data.

8) A method according to claim 1, wherein the method further comprises providing the notification to at least one of:
a) a merchant terminal of the merchant;
b) a merchant client device of the merchant; and
c) a customer client device of the customer.

9. A method according to claim 1, wherein the notification is at least one of:
a) a criteria notification provided to the merchant, the criteria notification indicating at least one of:
i) the one or more transaction criteria met by the plurality of transactions; and
ii) the identifier; and
b) an offer notification provided to the customer, the offer notification indicating at least one offer associated with the merchant.

10. A method according to claim 9, wherein the method further comprises:
a) determining the at least one offer based on the criteria met; and
b) providing the offer notification to at least one customer client device, the offer notification indicating the at least one offer and the customer client device being responsive to display an indication of the at least one offer.

11. A method according to claim 10, wherein the method further comprises determining the at least one offer by at least one of:
a) retrieving the at least one offer from stored offer data, the offer data defining offers associated with respective criteria; and
b) providing a criteria notification to one of a merchant terminal and a merchant client device, the criteria notification indicating the one or more transaction criteria met by the plurality of transactions, the one of the merchant terminal and the merchant client device being responsive to the criteria notification to:
i) determine the at least one offer; and
ii) provide an indication of the at least one offer to the at least one payment processing device.

12. A method according to claim 11, wherein the method further comprises, using one of the merchant terminal and the merchant client device:
a) displaying an indication of the met criteria; and
b) determining the at least one offer in accordance with merchant input commands.

13. A method according to claim 9, wherein the method further comprises, using the customer client device:
a) displaying an indication of the at least one offer;
b) selectively determining customer acceptance of the at least one offer in response to customer input commands; and
c) in response to customer acceptance, providing an indication of offer acceptance to the payment system.

14. A method according to claim 13, wherein the method further comprises:
a) receiving an indication of offer acceptance from the customer client device; and
b) at least one of:
i) providing an acceptance notification to one of a merchant terminal and a merchant client device; and
ii) causing the at least one offer to be performed.

15. A method according to claim 14, wherein the method further comprises causing the at least one offer to be performed by at least one of:
a) crediting a customer account of the customer; and
b) adjusting a debit of a customer account for a transaction.

16. A method according to claim 1, wherein the method further comprises, using one of a merchant terminal and a merchant client device, displaying an indication of the identifier, thereby allowing the merchant to provide an offer to a customer at least in part based on the identifier displayed on the customer client device.

17. A method according to claim 1, wherein the one or more transaction criteria include at least one of:
a) a number of transactions;
b) a frequency of transactions;
c) a transaction amount; and
d) transactions relating to one or more specific products.

18. A method according to claim 1, wherein the method further comprises causing a payment associated with the transaction to be performed.

19. A method according to claim 18, wherein the method further comprises receiving the transaction data from at least one acquirer processing system.

20. A method according to claim 1, wherein the method further comprises:
a) in a merchant terminal, providing an indication of the transaction to at least one acquirer processing system; and
b) in the at least one acquirer processing system, providing the transaction data to the at least one payment processing device.

21. A method according to claim 20, wherein the at least one payment processing device:
a) generates a payment file indicative of the transaction details; and
b) transfers the payment file to an issuer, the issuer being responsive to the payment file to cause an acquirer payment to be made from an issuer account to an acquirer account.

22. A method according to claim 20, wherein the at least one acquirer processing system causes the merchant payment to be made from an acquirer account to a merchant account.

23. (canceled)

24. A system for monitoring customer transactions, the system comprising at least one payment processing device that:
a) receives transaction data indicative of a transaction between a customer and a merchant, the transaction being performed in respect of a respective customer account;
b) determines an identifier associated with the transaction using mapping data indicative of associations between identifiers and customer accounts;
c) determines a plurality of transactions associated with the identifier;
d) analyzes the plurality of transactions to determine if the plurality of transactions meet one or more transaction criteria;
e) selectively generates a notification if the plurality of transactions meet the one or more transaction criteria; and
f) provides the notification to at least one of the merchant and the customer.
